(19) United States
(12) Patent Application Publication
(10) Pub. No.: US 2002/0099953 A1
(43) Pub. Date: Jul. 25, 2002

(54) Debugging of chipcards

(75) Inventors: Michael Johannes Deindl, Boeblingen (DE); Joachim Hagmeier, Stuttgart (DE); Torsten Enrico Teich, Sindelfinger (DE)

Correspondence Address: Marilyn Smith Dawkins, International Business Machines Corporation, Intellectual Property Law Dept., Internal Zip 4054, 11400 Burnet Road, Austin, TX, 78758, US

(73) Assignee: International Business Machines Corporation, Armonk, NY

(21) Appl. No.: 09/998,030

(22) Filed: Nov. 29, 2001

(30) Foreign Application Priority Data
Nov. 30, 2000 (EP) 00126908.3

(51) Int. Cl. G06F 12/14

(52) U.S. Cl. 713/200

(57) ABSTRACT

The present invention relates to programming of electronic data carrier applications. In particular, it relates to an improved debugging method and system for chipcard applications. It is based on the principle to use a conventional standard communication protocol between chipcard and terminal application for debugging purposes as well. Primarily, protocol extensions are implemented by special commands according to said protocol, but carrying debug instructions instead of the usual business commands. A wrapper logic wrapping the card driver recognizes due to a control information given in the previous command that the response comprises debug information and sends it to the debug software.

### 1. BACKGROUND OF THE INVENTION

1.1 Field of the Invention

The present invention relates to programming of electronic data carrier applications. In particular, the present invention relates to an improved debugging method and system for chipcard applications.

1.2 Description and Disadvantages of Prior Art

A new area of technology with increasing importance is represented by the increasing use and acceptance of chipcards, i.e., so-called SmartCards and their applications for many different business purposes.

Smartcards are intelligent devices having a processor, some memory chip and input and output means. For being seriously used they have installed a small-dimensioned operating system for controlling the operation of one or more business applications which are loadable into the memory of the Smartcard.

In general, it is important to be able to develop new or modified chipcard applications. An efficient test facility, a quick and comfortable way to correct programming mistakes are the main requirements for the commercial success envisaged with a chipcard application.

A modern debugger tool provides for this in general, i.e., when usual computer programs are developed, for example for running on a PC on a WINDOWS or a UNIX platform—but not for development of chipcard applications.

Debugging chipcard applications is much more difficult, instead. The reason is the limited comfort programming provisions for chipcards and the restricted, particular communication providable between chipcard and any respective terminal application. Said communication is performed via a serial interface, and on a binary, primitive level.

In particular, any communication between a chipcard and a terminal software follows a predetermined, low-level protocol, which is quite primitive compared to modern programming languages.

Basically, a master-slave communication is performed, wherein the terminal application program is the master and the chipcard application is the slave. When running a chipcard application in cooperation with the respective terminal application the master issues a command wrapped-in in a message-like format, the so-called Application Protocol Data Unit—abreviated further herein as APDU, sends it to the slave application and waits for response.

This complicates the debugging and thus an efficient development of chipcard applications:

Those standard communication protocols do not allow to send one or more further commands to a chipcard during the processing of a current command sent to the chipcard and performed by the chipcard application, because any further command may be sent to the chipcard after the card response corresponding to the current command is received from the card. Said one or more intermediate commands, however, are required for collecting status information from the chipcard memory in order to explore a bug relevant to the processing of said current command. Any initiative action originates from the card driver software being a part of the card reader device which is addressed by the terminal application. Per command issued to the chipcard application only one response can be received from the card. It is not possible under said standard protocols to make the card issue more than one responses per command. The card is a pure and fully restricted slave of the terminal application.

A prior art chipcard debugger is a software simulation of a chipcard which simulate the chipcard in structure and function. Thus, a simulation and analysis of the operating system as well as the chipcard application is possible, it suffers, however, from the basic fact that not the real chipcard but the simulation model therof is debugged. Thus, program bugs cannot be recognized with 100% probability and in the original runtime environment the chipcard application is intended to operate in.

A variation of this approach is disclosed in French patent application no. FR 2 667 419. It shows a hardware simulation, i.e., a hardware emulator of the chipcard. Said hardware emulator is a hardware device prototyping the structure and function of the chipcard as mentioned above. The control of said emulator device,—often a particular PC device is used for that—is performed by an externally connected standard PC. A debugging program is used which is hosted on the external PC. The communication between chipcard and terminal application is interrupted when a breakpoint is reached. The debug program may be used for exploring the status of the chipcard memory.

The disadvantage, however is the same as mentioned above: The chipcard is not tested and debugged under the original runtime environment. Thus, no efficient and reliable chipcard application development can be provided therewith.

1.3 Objects of the Invention

It is thus an objective of the present invention to provide a method and system which enables for debugging a chipcard application in its real-life runtime environment.

### 2. SUMMARY AND ADVANTAGES OF THE INVENTION

This objective of the invention is achieved by the features stated in enclosed independent claims. Further advantageous arrangements and embodiments of the invention are set forth in the respective subclaims.

The present invention is based on the principle to use a conventional standard communication protocol between chipcard and terminal for debugging purposes as well. Basically, any existing prior art communication protocol can be extended by the present invention's concepts by inventive extensions which provide for the usual debug commands like halt, step, set breakpoint at a specified address, reset breakpoint, display variable X, set variable X to value a, etc., for use in the direct communication between chipcard and terminal. Primarily, said extensions are implemented by special commands according to a standard protocol, but carrying debug instructions which is, however, evaluable by said chipcard application, instead of the usual business commands.

By said debug commands ‘hidden’ in the standard protocol the response behavior of the card is modified: The chipcard application processes a chipcard regular (business) command and reaches a breakpoint which was set before. Then, the chipcard application sends back a response according to the protocol requirements in which it tells a ‘wrapper logic’ to have reached said breakpoint. The wrapper logic now recognizes due to a control information given in the previous command that the response comprises debug information and sends it to the debug software. Thus, the master/slave protocol is fulfilled without the above mentioned business command having completed. A person controlling the debug software can now setup new debug commands for exploring the memory of the chipcard in order to find a bug. The request and the response follows the same principle as described before. After issueing a run command the chipcard application continues until the next business response has been issued by the chipcard application.

Currently widely used communication protocols, like T0, or T1 support for example 4 byte APDUs may be applied. At least one bit is now dedicated as a control information, in order to carry the information if the APDU is a debug APDU, or an APDU comprising regular business information for the terminal application or the smartcard application to process.

A wrapper software for the card driver or a respective modified card driver evaluates said control information in each regular prior art APDU transported from the chipcard application to the terminal. It decides if the APDU contains debug information or regular card application business information and feeds the respective information content, or the APDU itself to a debug control PC, or to the terminal application, respectively.

The prior art master/slave rules are followed, too. Thus, no time-out problems arise in the inventive scheme of operating.

If desired or useful in any sense, instead of the control information in form a particular return code, any type of protocol supplements like channels, etc., can be used as well for deciding if a card response comprises debug information or not, supposed said supplements are implemented by the card's operating system.

A particular advantage of the present invention is that neither terminal application nor the actual chipcard application need to be modified. Instead, for debugging the wrapper module simply has to be loaded into the chipcard. When the application runs perfectly the wrapper module will be removed from the chipcard which is then ready to be produced in series for public use.

Further, the inventive principle can be advantageously applied to Programming languages having an Interpreter character as it is the JAVA language, for example.

### 3. BRIEF DESCRIPTION OF THE DRAWINGS

The present invention is illustrated by way of example and is not limited by the shape of the figures of the accompanying drawings in which:

FIG. 1 is a schematic illustration showing the essential elements of a preferred embodiment of the present invention, and

FIG. 2 is a schematic flow diagram showing the most essential steps during the control flow during a debug run of a chipcard application according to a preferred embodiment of the inventional method.

### 4. DESCRIPTION OF THE PREFERRED EMBODIMENT

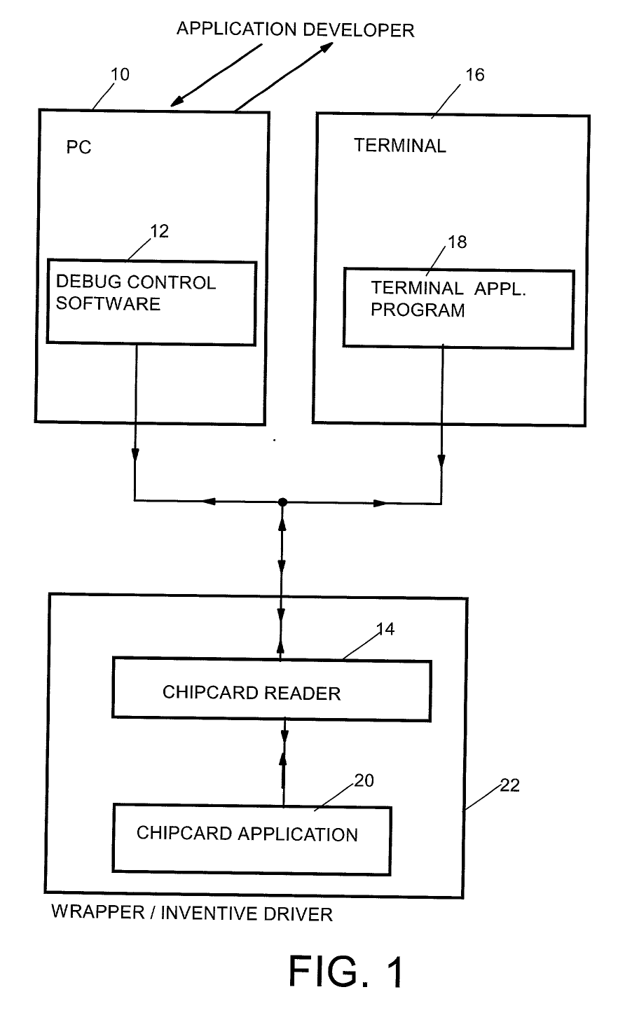

With general reference to the figures and with special reference now to FIG. 1 a usual standard PC 10 is provided as a controlling interface for the developer. A debug control program 12 is loaded and run for debug purposes. Said PC 10 is connected to a chipcard reader 14, as well as a terminal 16 having installed a terminal application program 18 for cooperating with the chipcard application 20 which is subjected to the debug process.

Both programs—debug control 12 and terminal application 18—are logically connected to an inventive wrapping module 22 which acts as a wrapper for the conventional card driver used in the chipcard reader 14. Thus, said component 22 acts as an input and an output filter for communication from and to the debug program 12 and the terminal application 18, respectively.

Alternatively, instead of the wrapper component 22 a modified card driver my be used which comprises equivalent logic functions.

The standard communication protocol—here T1—is used in a double sense. First, between the terminal application 18 and the chipcard application 20 as in prior art, and second—according to the present inventional embodiment between the debug control software 12 and the chipcard application to transport special purpose debug commands between the debug control software and the chipcard application.

Some examples for debug commands and responses are illustrated next below according to the T1 protocol:

1. Set breakpoint at address xxyy, and set the special return code
to ′9F01′ (in case the breakpoint has reached)
command: F0 01 00 00 04 xx yy 9F 01
response: 9000
2. Reset breakpoint at address xxyy
command: F0 02 00 00 02 xx yy
response: 9000
3. Continue execution
command: F0 03 00 00 00
response: <original response data and return code of the
interrupted command>
4. Display variable at address xxyy
the command returns the byte value nn
command: F0 04 00 00 02 xx yy
response: nn 9000

A business command and the corresponding responses is as follows:

1. Command “Mutual Authenticate”
(this command is used to authenticate the external world to a chipcard
application, and vice versa)

| | |
|---|---|
| command: | 00 82 00 xx 10 <16 bytes command data> |
| responses: | <8 bytes response data> 9000 |
| | indicating successfully execution |
| | 9F01 |
| | indicating that the breakpoint has been reached |
| | (according to above example) |

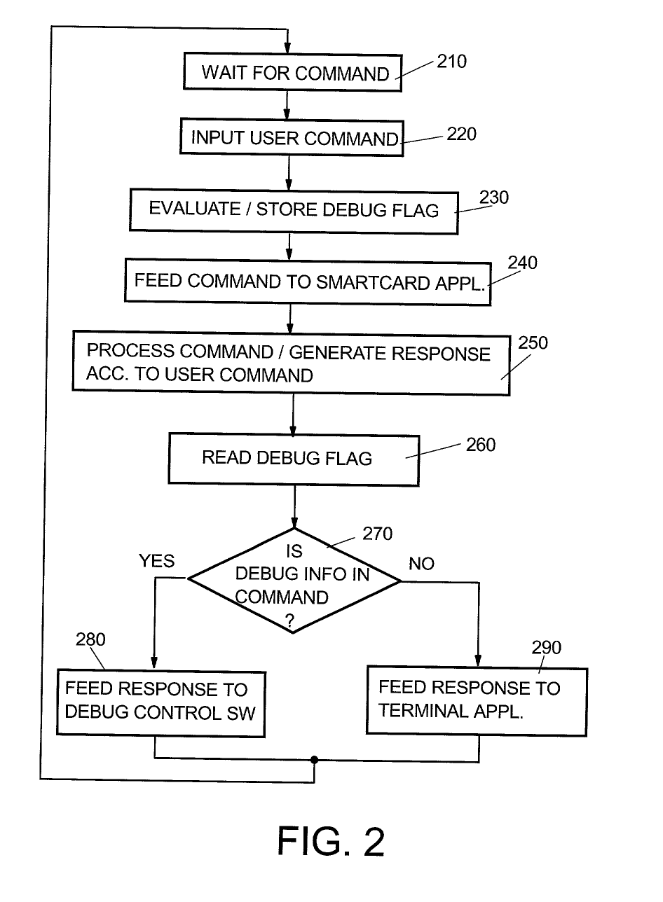

With additional reference now to FIG. 2 the essential steps in the control flow of the method according to the inventional embodiment are described next below while an exemplary breakpoint is worked on. Most of steps illustrated in the drawing are performed by said wrapper program 22.

After having loaded the wrapper program for the chipcard driver on the PC 10 and the debug control software was started the wrapper program waits for receiving an input command (APDU), step 210.

Then, the application developer enters a debug command 'set breakpoint at address xxyy, step 220.

The wrapper 22 receives and evaluates it. It stores the debug flag comprised of the command. In case of said debug command it receives the valid value of the debug bit and stores it, step 230.

Then the wrapper feeds said command to the original, ‘wrapped’ card driver 14 and by that to the chipcard application, step 240. The card driver stores said breakpoint according to said command for address xxyy, step 250, and sends a confirmatory response back to the card driver, and thus the wrapper.

The wrapper evaluates—step 260—its debug flag just stored before and recognizes that the answer concerns debug information, step 270. As a response always relates to the last command received this measure is suffiently reliable to discern debug commands from business commands.

Thus the wrapper is enabled to feed said response APDU generated by the card application to the debugging control software 12—see back to FIG. 1. If it was a response to a business command APDU the wrapper would have fed it to the terminal application in order to continue the application regularly, step 290.

Under the assumption that now a regular—not-debugging command is actually issued by the developer basically the same schema as illustrated in FIG. 2 is followed. The chipcard executes said command and continues running until said breakpoint is reached which was entered by the developer.

Now, any memory status information can be requested from the chipcard application by issueing debug commands according to the above mentioned scheme. Said data can be evaluated and bugs be recognized without any timeout problem being present. If desired the developer can pause the program and rebegin his work the next day.

On a ‘Run’ command, finally, and when no more breakpoint being present the chipcard application continues and the usual business dialog between chipcard application and terminal application is followed.

Thus, according to the inventive principle to hide debug commands in regular APDUs and filtering the card responses as described above the card application can be tested under real life conditions as it was mentioned before.

In the foregoing specification the invention has been described with reference to a specific exemplary embodiment thereof. It will, however, be evident that various modifications and changes may be made thereto without departing from the broader spirit and scope of the invention as set forth in the appended claims. The specification and drawings are accordingly to be regarded as illustrative rather than in a restrictive sense.

The present invention can be realized in hardware, software, or a combination of hardware and software. A wrapper/debug control tool according to the present invention can be realized in a centralized fashion in one computer system, or in a distributed fashion where different elements are spread across several interconnected computer systems.

Even the wrapper program module is not necessarily loaded in the chipcard storage itself. It can be externally stored and run as well, as long as th econnections are logically correct as illustrated herein or a person skilled in the art would connect. Any kind of computer system or other apparatus adapted for carrying out the methods described herein is suited. A typical combination of hardware and software could be a general purpose computer system with a debug control program that, when being loaded and executed, controls the computer system such that it carries out the methods described herein.

The present invention can also be embedded in a computer program product, which comprises all the features enabling the implementation of the methods described herein, and which—when loaded in a computer system—is able to carry out these methods.

Computer program means or computer program in the present context mean any expression, in any language, code or notation, of a set of instructions intended to cause a system having an information processing capability to perform a particular function either directly or after either or both of the following

a) conversion to another language, code or notation;

b) reproduction in a different material form.

1. A method for debugging chipcard applications comprising:
using a chipcard application/terminal application standard communication protocol for transporting business commands of a terminal application to a chipcard application and debug information of a debug control program to the chipcard application; and
evaluating the business commands and debug information in a module layered between between the chipcard application and the terminal application, and between the chipcard application and the debug control program.

2. The method of claim 1 in which said debug information is transported within Application Protocol Data Units (APDUs).

3. The method of claim 1 applied to JAVA cards, and filesystem oriented chipcards.

4. The method of claim 1 wherein evaluating the business commands and debug information further comprises determining whether an incoming command is an incoming debug instruction.

5. The method of claim 4 further comprising:
sending the incoming command to the chipcard application;
receiving a response from the chipcard application; and
sending the response to the debug control program if the incoming command was determined to be an incoming debug instruction.

6. The method of claim 4 further comprising:
sending the incoming command to the chipcard application;
receiving a response from the chipcard application; and
sending the response to the terminal application if the incoming command was determined not to be an incoming debug instruction.

7. A method for debugging chipcard applications comprising:
evaluating debug control information to distinguish between debug information input and business information input to a chipcard application;
sending, based upon the evaluation, debug information output to a debug control program and business information output to a terminal application.

8. A computer program module having computer readable instruction means on a computer readable medium, comprising:
instruction means enabling an interface for input to and output from a chipcard driver; and
instruction means enabling an evaluation of debug control information for distinguishing between debug information input and business information input to the chipcard application.

9. The computer program module of claim 8 further comprising instructions means for feeding, dependent upon an evaluation result,
i) an output response, from a chipcard application, of debug information to a debug control program; and
i) business information output, issued from the chipcard application, to a terminal application.

10. The computer program module of claim 9 wherein the computer program module resides in a chipcard driver program.

11. A chip card driver comprising:
means for enabling an evaluation of debug control information for distinguishing between debug information input and business information input to a chipcard application;
means for sending, based upon the evaluation, debug information output to a debug control program and business information output to a terminal application.

12. A data processing a processor and memory, comprising:
an interface module having means for interfacing between a chipcard application and a debug control program and between the chipcard application and a terminal application;
means for enabling an evaluation of debug control information for distinguishing between debug information input and business information input to a chipcard application; and
means for sending, based on the evaluation, debug information output to a debug control program and business information output to a terminal application.
